(19) United States
(12) Patent Application Publication
(10) Pub. No.: US 2005/0007103 A1
(43) Pub. Date: Jan. 13, 2005

(54) Sensor assembly for sensing direction of rotation and/or position of an object

(76) Inventors: Thaddeus Schroeder, Rochester Hills, MI (US); Bruno P. B. Lequesne, Troy, MI (US)

Correspondence Address: JIMMY L. FUNKE;DELPHI TECHNOLOGIES, INC., Legal Staff, Mail Code: 480-410-202, P.O. Box 5052, Troy, MI, 48007-5052, US

(21) Appl. No.: 10/615,112

(22) Filed: Jul. 8, 2003

(51) Int. Cl. G01B 7/30

(52) U.S. Cl. 324/207.25

(57) ABSTRACT

A sensor assembly and method for sensing direction of rotation and/or position of an object are provided. The sensor assembly includes a target wheel. A pair of sensing elements may be configured to generate respective signals as the wheel rotates in response to structure on the target wheel. A first circuit may be coupled to receive a signal from at least one of the sensing elements for detecting direction of rotation of the target wheel. A second circuit may be coupled to receive each signal from the sensing elements for detecting position of the target wheel.

### FIELD OF THE INVENTION

The present invention is generally related to motor vehicle sensors, and, more particularly, the present invention is directed to a sensor assembly for detecting direction of motion and/or position of a rotating object.

### BACKGROUND OF THE INVENTION

Modern motor vehicles are equipped with numerous sensors that provide detailed information regarding the operation of the vehicle. This information may be displayed for a driver or it may be processed and provided to various vehicle control systems. A target wheel sensor, for example, may be used to determine the angular speed or angular position of a rotating object in the vehicle, e.g., a crankshaft and a driveshaft. In either case, a target wheel may be engaged with the rotating object for inducing signals in one or more sensors positioned next to the target wheel, with the signals representing the angular position or angular speed of the rotating object. These signals can be used in various control systems, e.g., an ignition system and a speed control system. The present invention recognizes that certain applications require the detection of not only the position of the object, but the detection of the direction of motion of the rotating object as well.

### SUMMARY OF THE INVENTION

Generally, the present invention fulfills the foregoing needs by providing in one aspect thereof, a sensor assembly for sensing direction of rotation and/or position of an object. The assembly comprises a target wheel. A pair of sensing elements may be configured to generate respective signals as the wheel rotates in response to structure on the target wheel. A first circuit may be coupled to receive a signal from at least one of the sensing elements for detecting direction of rotation of the target wheel. A second circuit may be coupled to receive each signal from the sensing elements for detecting position of the target wheel.

The present invention further fulfills the foregoing needs by providing in another aspect thereof, a method for sensing direction of rotation and/or position of an object. The method allows providing a target wheel. The method further allows arranging a pair of sensing elements to generate respective signals as the wheel rotates in response to structure on the target wheel. A first circuit is coupled to receive a signal from at least one of the sensing elements for detecting direction of rotation of the target wheel. A second circuit is coupled to receive each signal from the sensing elements for detecting position of the target wheel.

### BRIEF DESCRIPTION OF THE DRAWINGS

These and other advantages of the invention will be more apparent from the following description in view of the drawings that show:

FIG. 1 is a schematic representation of an exemplary differential sensor for detecting rotation direction and/or position of an object.

FIG. 2 is a block diagram of a sensor assembly embodying aspects of the present invention for processing output signals from the sensor of FIG. 1.

FIG. 3 is a schematic of one exemplary circuit stage, e.g., peak and valley detector, as may be used for providing signal-conditioning to the output signals from the sensor of FIG. 1.

FIG. 4 is a schematic of another exemplary circuit stage, e.g., zero crossings detector, as may be used for providing signal-conditioning to the output signals from the sensor of FIG. 1.

FIG. 5 is a plot of exemplary waveforms from the sensor of FIG. 1 and outputs from either of the circuit stages from FIG. 3 or FIG. 4.

FIG. 6 is a block diagram of another embodiment of a sensor assembly for detecting rotation direction and/or position of an object.

### DETAILED DESCRIPTION OF THE INVENTION

A sensor assembly 10 for detecting rotation direction and/or position of an object may include a target wheel 12, a magnet 14, and at least two sensing elements 15 and 16 placed therebetween. In one exemplary embodiment, the sensing elements may comprise Hall sensing elements. It will be appreciated that other galvanomagnetic sensing elements, such as magnetoresistive sensing elements, may be used in lieu of the Hall-sensing elements. The magnet and the sensing elements are positioned so that as the target wheel rotates, structural features on the wheel, such as teeth and slots, cause each sensing element to output a signal having a respective time displacement relative to one another. As described in greater detail below, each of the signals may be processed to extract information indicative of the direction of rotation and/or position of the object.

For example, the signals may be (but need not be) in quadrature relative to one another (e.g., displaced in space relative to one another by a fourth of the tooth pitch). Extracting direction of rotation from two signals in quadrature (or, more generally, displaced in time from one another by a known amount) should conceptually be a fairly straightforward task. In practice, however, a judicious selection of an appropriate signal-processing circuit should be made to avoid or reduce the possibility of erroneous indications, such as otherwise could occur due to either target vibration or wobble, or dithering at standstill.

In one known exemplary sensor assembly, it is believed that the sole focus has been on position detection. That is, detecting the direction of rotation of the target wheel has not been a consideration. One aspect of the present invention is premised on adapting a differential sensor assembly traditionally used just for sensing position of the target wheel so that, with no changes to the sensing devices and just a few and relatively inexpensive circuit additions, such an assembly can be innovatively used to also detect the direction of rotation of the wheel. A sensor assembly embodying aspects of the present invention may take advantage of integrated circuit packages that commonly may be configured or pre-packaged to extract information indicative of position only. Thus, aspects of the present invention innovatively enhance and add to the versatility of a sensing assembly traditionally used in the art just for position detection.

A block diagram of a sensor assembly 100 embodying aspects of the present invention is shown in FIG. 2. The block diagram shows an exemplary circuit topology comprising a circuit 102 for detecting position and a circuit 104 configured to detect the direction of rotation of the target wheel. In one exemplary embodiment, circuit 104 comprises a pair of signal-conditioning circuit stages (e.g., circuit stages 104₁ and 104₂), coupled to separately receive the output signal from each of the respective sensing elements.

As will be appreciated by those skilled in the art, position-detection circuit 102 may consist of any conventional circuit devised for that purpose. For instance, the commercially available circuit described in datasheets titled “ATS660LSB: True Zero-Speed Hall-Effect Adaptive Gear-Tooth Sensor”, presently downloadable at Uniform Resource Locator (URL) http://www.allegromicro.com/sf/0660/ of Allegro, Inc. As stated above, the present invention advantageously does not require any modification of position-detection circuit 102. Instead, a sensor assembly embodying aspects of the present invention allows for a straightforward add-on, both functionally, and structurally.

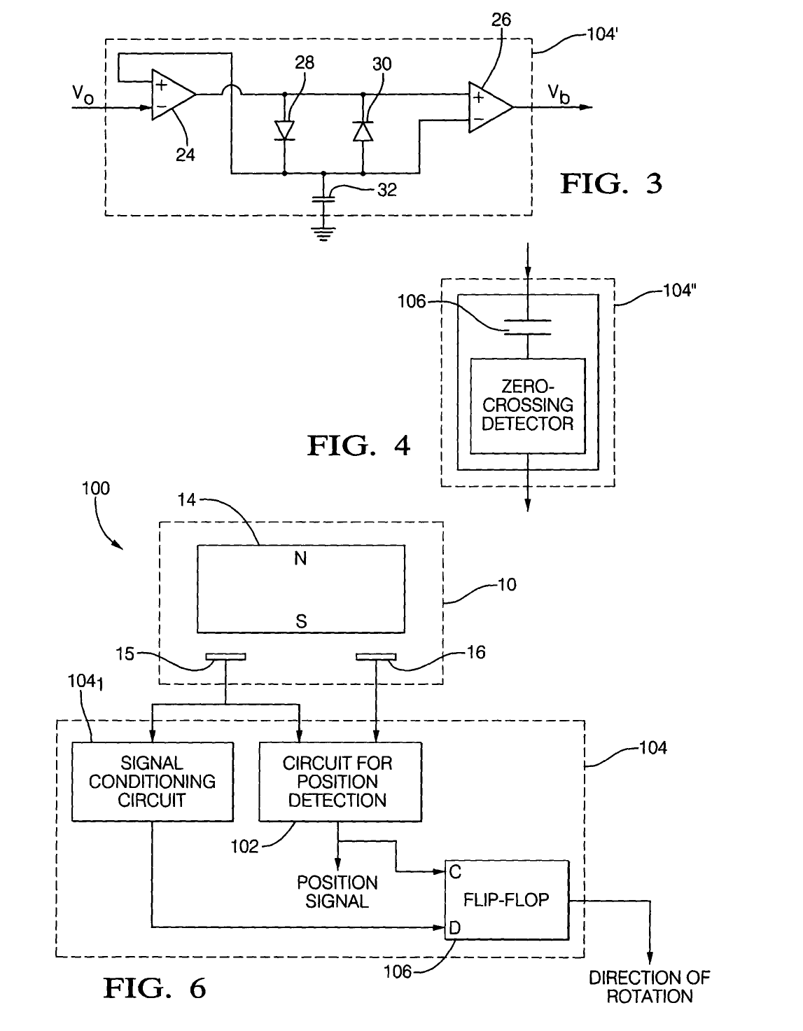

In one exemplary embodiment illustrated in FIG. 3, each circuit stage may be a circuit stage 104^{I} comprising at least one peak and valley detector. The circuit of FIG. 3 comprises an operational amplifier 24 having a high gain, such as a gain factor of 100,000. A circuit comprised of a pair of parallel coupled diodes 28 and 30 and a capacitor 32 is coupled between the output of the amplifier 24 and the ground reference potential. The parallel coupled diodes are oppositely poled, i.e., the anode of one being connected to the cathode of the other. The voltage across the capacitor is coupled to the negative input of the amplifier 24 to be compared with the voltage Vₒ which is coupled to the positive input of the amplifier 24.

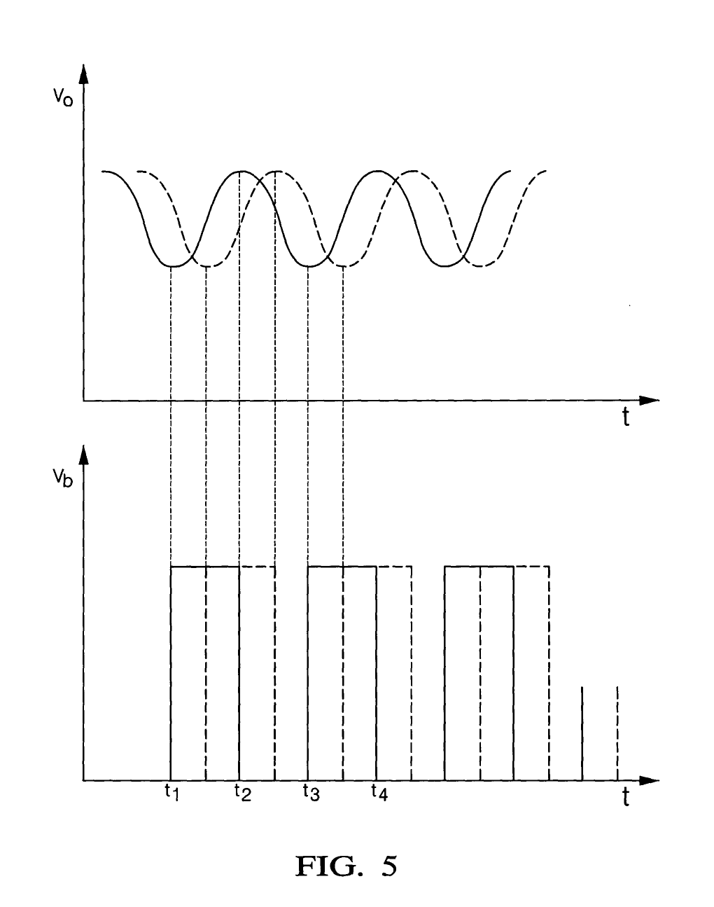

The voltage across the parallel coupled diode pair 28 and 30 is coupled to the positive and negative inputs of a comparator switch 26. The output of the comparator switch 26 comprises the voltage pulses V_{b} that constitute the pulse stream output of the signal-conditioning circuit 104^{I}, as represented by the exemplary digital signals shown in FIG. 5.

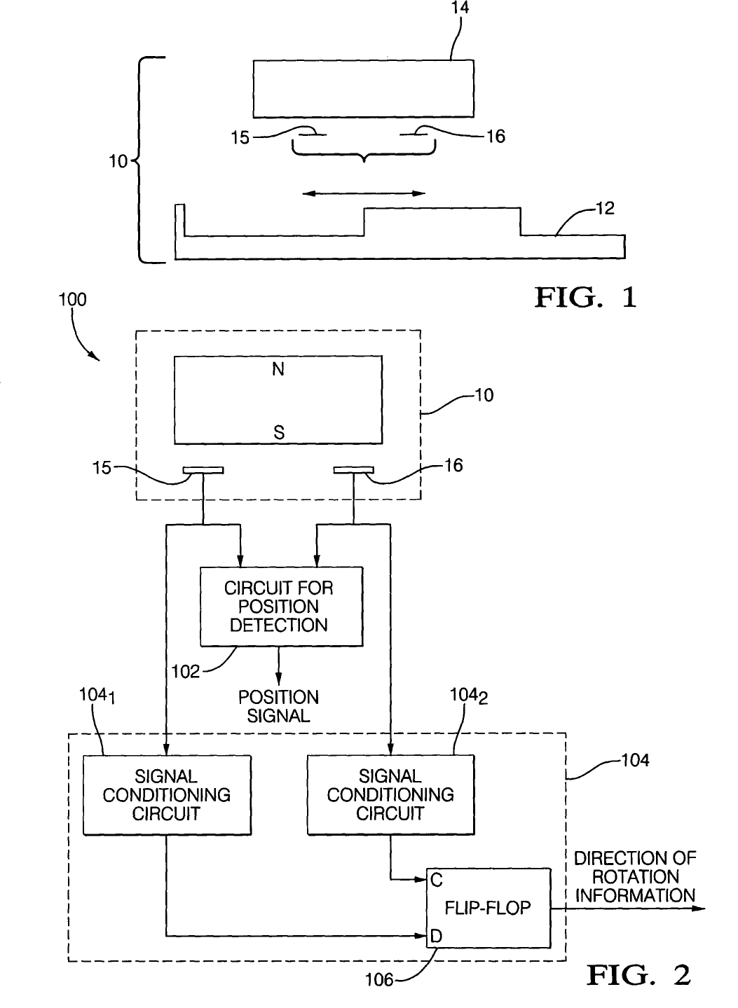

The operation of the circuit of FIG. 3 may be described with reference to the voltage diagrams of FIG. 5 where the upper diagram represents each respective input signal Vₒ developed across each of the sensing elements 15 and 16 (FIGS. 1 and 2) and the lower diagram depicts each pulse signal V_{b} that constitutes the pulse stream outputs of the signal-conditioning circuit 104^{I}.

The operational amplifier 24 compares the voltage across the capacitor 32 with the voltage Vₒ and charges or discharges the capacitor 32 through the diode pair 28 and 30 to maintain the capacitor voltage equal to the value of voltage Vₒ. When the capacitor voltage is less than voltage Vₒ, the amplifier 24 charges the capacitor 32 through the forward biased diode 28 and when the capacitor voltage is greater than voltage Vₒ, the amplifier 24 discharges the capacitor 32 through the forward biased diode 30. Therefore, during the period t₁ to t₂ during which the voltage Vₒ in the solid line waveform is increasing to its peak value, the amplifier 24 charges the capacitor 32 through the diode 28 to maintain the capacitor voltage equal to the input voltage Vₒ. During the period t₂ to t₃ during which the voltage Vₒ is decreasing to its minimum value, the amplifier 24 discharges the capacitor 32 through the diode 30 to maintain the capacitor voltage equal to the input voltage Vₒ. During the subsequent period t₃ to t₄ the conditions are as described with respect to the time period t₁ to t₂.

While the capacitor 32 is being charged or discharged, the input voltage to the comparator switch 26 is equal to the value of the forward biased diode junction voltage drop (typically about 0.6 volts). However, the input voltage to the comparator switch 26 has one polarity when the diode 28 is conducting during the charging period of the capacitor and an opposite polarity when the diode 30 is conducting during the discharging period of the capacitor. Specifically, the voltage at the positive input of the switch 26 is greater than the voltage at its negative input when the diode 28 is conducting while the capacitor is being charged and the voltage at its negative input is greater than the voltage at its positive input when the diode 30 is conducting while the capacitor is being discharged. The resulting voltage pulses V_{b} at the output of the comparator switch 26 relative to the voltage Vₒ is illustrated in FIG. 5. These pulses comprise each pulse stream output of the signal-conditioning circuit 104^{I} of FIG. 3. That is, the solid line waveforms represent the signals associated with one of the sensing elements, while the dashed line waveforms represent the signals associated with the other of the sensing elements. In one exemplary embodiment, each pulse stream output may be supplied to a flip-flop 106 to determine which of the pulse streams leads (or lags) the other. One of the pulse streams would be used as a clocking signal and the other pulse stream would be used as a data input into the flip-flop. This information would allow determining the direction of rotation of the target wheel. For example, a leading indication of one pulse stream relative to the other pulse stream may correspond to a clockwise rotation while a lagging indication between the same pulse streams may correspond to counter-clockwise rotation.

In another exemplary embodiment illustrated in FIG. 4, each circuit stage may comprise a circuit stage 104^{II} comprising at least one zero crossings detector. In that case, a capacitor 106 is located on the input side of the signal-conditioning circuit 104^{II}, as shown in FIG. 4. The pulse stream output supplied by circuit stages 104^{II} would be as exemplarily discussed in the context of the digital waveforms of FIG. 5. In operation, each pulse stream output of the circuit stages 104^{II} may be coupled to a flip-flop, as described above, for extracting the direction of rotation information. For readers desirous of background information regarding exemplary zero-crossing detectors, reference is made to the textbook titled “The Art of Electronics,” 2^{nd} Ed., by P. Horowitz and W. Hill available from Cambridge University Press. See, for example, FIG. 4.78, page 242. See also, “Linear Applications Databook” from National Semiconductor, FIG. 10, page 260, both herein incorporated by reference.

An alternative configuration of the sensor assembly may be as shown in FIG. 6. In this alternative embodiment, just one of the signals from the sensing elements would be routed separately, as described earlier, to signal-conditioning circuit 104. Circuit 104 in this embodiment would comprise a single circuit stage 104₁ that may be either the peak-and-valley stage or the zero-crossing circuit stage described above. The differential position signal would be used in lieu of the signal from the other sensing element as the clocking signal or the data input to the flip-flop. For example, the position signal could be used as a clocking signal for determining whether the signal from the single sensing element leads or lags, thereby obtaining information for determining a direction of rotation of the target wheel.

This alternative sensor assembly has the advantage of using even fewer additional circuitry. However, the output signals from circuits 104 and 102 may be less likely to be spaced in quadrature, and more likely to be displaced in time by some known amount, which is still sufficient for determining the direction of rotation.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A sensor assembly for sensing direction of rotation and/or position of an object, the assembly comprising:
a target wheel;
a pair of sensing elements configured to generate respective signals as the wheel rotates in response to structure on the target wheel;
a first circuit coupled to receive a signal from at least one of the sensing elements for detecting direction of rotation of the target wheel; and
a second circuit coupled to receive each signal from the sensing elements for detecting position of the target wheel.

2. The sensor assembly of claim 1 wherein said first circuit comprises a pair of circuit stages, each of said stages coupled to respectively receive a signal from a respective one of the sensing elements.

3. The sensor assembly of claim 2 further comprising a flip-flop coupled to receive the output signals from the circuit stage pair for detecting direction of rotation to trigger a signal indicative of the direction of rotation of the target wheel.

4. The sensor assembly of claim 1 wherein each circuit stage for sensing direction of rotation comprises a peak and valley detector.

5. The sensor assembly of claim 1 wherein each circuit stage for sensing direction of rotation comprises a zero-crossings detector.

6. The sensor assembly of claim 1 wherein said first circuit comprises a single circuit stage coupled to receive a signal from a respective one of the sensing elements.

7. The sensor assembly of claim 1 further comprising a flip-flop coupled to receive the output signal from the single circuit stage and an output signal from the second circuit to trigger a signal indicative of the direction of rotation of the target wheel.

8. A method for sensing direction of rotation and/or position of an object, the method comprising:
providing a target wheel;
arranging a pair of sensing elements to generate respective signals as the wheel rotates in response to structure on the target wheel;
coupling a first circuit to receive a signal from at least one of the sensing elements for detecting direction of rotation of the target wheel; and
coupling a second circuit to receive each signal from the sensing elements for detecting position of the target wheel.

9. The method of claim 8 wherein coupling said first circuit comprises coupling a pair of circuit stages, each of said stages coupled to respectively receive a signal from a respective one of the sensing elements.

10. The method of claim 9 further comprising triggering a signal indicative of the direction of rotation of the target wheel in response to a timing relationship between the output signals from the circuit stage pair.

11. The method of claim 9 further comprising detecting peaks and valleys in the signals received by each circuit stage.

12. The method of claim 9 further comprising detecting zero crossings in the signals received by each circuit stage.

13. The method of claim 8 wherein coupling said first circuit comprises coupling a single circuit stage to receive a signal from a respective one of the sensing elements.

14. The method of claim 8 further comprising triggering a signal indicative of the direction of rotation of the target wheel in response to a timing relationship between the output signal from the single circuit stage and the second circuit.
